(19) United States
(12) Patent Application Publication
(10) Pub. No.: US 2002/0051226 A1
(43) Pub. Date: May 2, 2002

(54) Gateway device with private branch exchanging function

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/020,390

(22) Filed: Oct. 30, 2001

(30) Foreign Application Priority Data
Nov. 2, 2000 (JP) 2000-336508
Jul. 27, 2001 (JP) 2001-228510

(51) Int. Cl. H04N 1/40

(52) U.S. Cl. 358/443

(57) ABSTRACT

A gateway device with private branch exchanging function capable of carrying out transmission of image data using a desired network without carrying out any complicated operations by a user. When receiving an input of a facsimile number and the image data from the user, the facsimile machine FAX1a connected to the private branch network K transmits the facsimile number and the image data to the gateway device GTW1 functioning as a PBX. When receiving the facsimile number and the image data from the facsimile machine FAX1a, the gateway device GTW1 confirms the number attached to the front of the facsimile number, and when the number is “0”, transmits the image data to the facsimile machine FAX2 via the public switched telephone network PSTN. When the number is “*”, the gateway device GTW1 transmits the image data to the gateway device GTW2 via the Internet NTW.

### CROSS REFERENCES TO RELATED APPLICATIONS

This application claims priority under 35 USC 119 of Japanese Patent Application Nos. 2000-336508 and 2001-228510 filed in JPO on Nov. 2, 2000 and Jul. 27, 2001 respectively, the entire disclosures of which are incorporated herein by reference.

### BACKGROUND OF THE INVENTION

1. Field of the Invention

The present invention relates to a gateway device with private branch exchanging function that is connected to the computer communication network such as the Internet and can communicate with such a network.

2. Description of the Related Art

A computer communication network, which is capable of carrying out transmission and receiving of various kinds of data via the Internet networked by connecting the LAN (Local Area Network) by means of the communication line, has been spread recently. When using such a computer communication network, a user is able to communicate with the computers of the whole world, not only within domestic area, just by paying the communication expenses (network charges and connection expenses to the provider) to the nearest ISP (Internet Service Provider).

The transmission and receiving process of the image data between the facsimile machines when carrying out facsimile communication by utilizing the protocol of either T.38 or SMTP via the Internet as the computer communication network will be described in the following in reference to FIG. 7. In FIG. 7, reference number 100 designates a facsimile machine of a transmitting side, 200 designates a facsimile machine of a receiving side, 300 designates a gateway device of the transmitting side, and 400 designates a gateway device of the receiving side. The gateway device 300 is connected to the facsimile machine 100 via PSTN, and the gateway device 400 is connected to the facsimile device 200 via PSTN. The gateway device 300 is connected the gateway device 400 via the Internet NTW or PSTN. Moreover, the gateway device mentioned here is a device having a function of connecting the public switched telephone network PSTN and the Internet NTW, and is provided in aforementioned Internet service provider, for example. Furthermore, the gateway device 300 and the gateway device 400 have the Internet facsimile communication function by T.30 protocol, the real time Internet facsimile communication function by T.38 protocol, or the communication function of the electronic mail by SMTP.

First, the case in which the communication function by T.38 protocol is utilized will be described. The facsimile machine 100 modulates the image data to be transmitted into an analog voice signal, and transmits it to the gateway device 300 via the public switched telephone network PSTN, following the conventional facsimile communication procedure (T. 30 protocol). Next, the gateway device 300 demodulates the analog vice signal of the image data received from the facsimile machine 100 into a digital signal, and transmits the digital signal to the gateway device 400 via the Internet NTW by T.38 protocol. Then, the gateway device 400 modulates the digital signal received from the gateway device 300 into an analog voice signal, and transmits the analog voice signal to the facsimile machine 200 via the public switched telephone network PSTN by the conventional facsimile communication procedure. The facsimile machine 200 receives the image data transmitted from the facsimile machine 100 in real time herewith.

Further, as in the manner stated above, the communication, which is carried out between the facsimile machine 100 and the gateway device 300, and between the gateway device 400 and the facsimile machine 200, follows the recommendation T.30 of the ITU (International Telecommunication Union) which defines the facsimile communication using the public switched telephone network. Moreover, the communication carried out between the gateway device 300 and the gateway device 400 is carried out following the recommendation T.38 of the ITU which defines the facsimile communication using the computer communication network.

Next, the case in which the electronic mail function by SMTP is utilized will be described in reference to the example shown in aforementioned FIG. 7. The facsimile machine 100 modulates the image data to be transmitted into an analog voice signal and transmits the analog voice signal to the gateway device 300 via the public switched telephone network PSTN following the conventional facsimile communication procedure.

The gateway device 300 demodulates the analog voice signal received from the facsimile machine 100 into image data temporarily, and then converts it into TIFF (Tagged Image File Format) format, which is a general image format used in the computer. Further, the specification of the TIFF is publicized by Adobe Systems, and a Class corresponding to each for handling various kinds of data such as multivalue of white and black, or full color, not for only the binary of white and black, is defined. CLASS F which is one of these defines the image data of G3 format. Therefore, just by carrying out a relatively easy process such as adding the TIFF header information of the CLASS F, to the top of the image data received from the facsimile machine 100, the image data can be converted into the TIFF format. The facsimile image data with the TIFF header information of the CLASS F attached, will be referred to as the “TIFF image data” hereafter.

Next, the gateway device 300 converts the binary data of the TIFF image data into text data since there are computers connected to the Internet, which cannot handle electronic mails of binary data. Therefore, when transmitting binary data of such as the TIFF image data, the binary data is converted into text data first and then transmitted so that the other end can reliably receive the electronic mail. Further, the text data handled in the Internet is defined as a code of 7 bits in the RFC (Request For Comments) 822 which is a document issued by the IETF (Internet Engineering Task Force).

Consequently, by way of example, when the conversion into text data is carried out by using the base 64 which is one of the encoding types of the MIME (Multipurpose Internet Mail Extensions), the binary data is converted into text data by being replaced with one of the 64 kinds of characters (alphabets of capital letters and small letters, numbers, +, /) in 6 bit units. Further, the MIME is defined in aforementioned RFC, and for example, the encoding types, such as “7bit”, “8bit”, “binary” are also defined, apart from aforementioned base 64.

Next, the gateway device 300 arranges the file to be transmitted into an electronic mail format. Specifically, the file is edited into an electronic mail format by attaching the mail header information as the communication management information to the TIFF image data converted into text data. Such operation by the gateway device 300 is essential, for it is defined to attach the designated header information to the electronic mail of the Internet. When transmitting the file, as shown in FIG. 8, the following header information of each items are attached: “Date” (the transmitting time of the electronic mail), “From:” (the sender of the electronic mail), “To:” (the destination of the electronic mail), “Subject” (the title of the electronic mail, specifically encoding form), “Cc:” (the destination of the copy of the electronic mail).

Next, the gateway device 300 transmits the electronic mail prepared as described above, to the gateway device 400 via the Internet NTW by SMTP. Then, the gateway device 400 separates the text and the communication management information (mail header) from the electronic mail received from the gateway device 300, takes out only the TIFF image data converted into the text data, and converts into the TIFF format which is binary data. Furthermore, it is converted into image data of a normal facsimile format, and then transmitted to the facsimile machine 200 under the conventional facsimile communication procedure.

As a result, the facsimile communication using the computer communication network (Internet NTW) can be carried out between the facsimile machine 100 and the facsimile machine 200 via the gateway device 300 and the gateway device 400 connected by the Internet NTW and possessing T.38 protocol or SMTP function.

However, even if using either of T.38 or SMTP, when carrying out facsimile communication by using the Internet NTW as in the manner stated above, the facsimile machine 100 of the transmitting side is to call the gateway device 300 of the transmitting side via the public switched telephone network PSTN, and not to call the facsimile machine 200 of the receiving side. Therefore, in such case, there is a need to notify the facsimile number (telephone number) of the facsimile machine 200 of the receiving side to the gateway device 300 of the transmitting side. As a result, when transmitting image data to the facsimile machine 200 from the facsimile machine 100, the user is required to specify the telephone number of both machines of the gateway device 300 and the facsimile machine 200. Thus, the operation is to be complicated.

Moreover, since the communication carried out through the Internet is so-called connectionless type communication, comparing to the connection oriented type communication, its reliability is low. Therefore, when carrying out facsimile communication via the Internet NTW, comparing to the regular facsimile communication using only the public switched telephone network, the case in which the facsimile machine 200 cannot receive the image data due to the failure in the communication between the gateway device 300 and the gateway device 400, is more likely to occur.

### SUMMARY OF THE INVENTION

The present invention was made in consideration to the circumstance mentioned above. It is an object of the present invention to provide a gateway device with private branch exchanging function capable of carrying out the following operations: when image data and identifying information such as the facsimile number of the destination are received from the facsimile machine connected to the private branch network, it is judged whether or not to use the private branch network, to use only the public switched telephone network, or to use the computer communication network, based on the identifying information, and by transmitting the image data to the determined network, the user can transmit the image data using the desired network without any complicated operations from the facsimile machine of the transmitting side.

It is another object of the present invention to provide a gateway device with private branch exchanging function capable of completing the transmission of the image data reliably, by retransmitting the same image data using only the public switched telephone network, in the case of failing to transmit the image data by using the computer communication network.

In addition, it is a still further object of the present invention to provide a gateway device with private branch exchanging function for communicating in real time communication using T.38 protocol when transmitting image data on the computer communication network.

An even further object of the present invention is to provide a gateway device with private branch exchanging function communicating by SMTP by converting the image data into an electronic mail when transmitting the image data on the computer communication network.

The inventor has paid attention to the following point: when the facsimile machine is located within the premises of a corporation for example and is connected to the private branch network, the facsimile machine is automatically connected to the PBX (Private Branch Exchange) when transmitting image data. As a result, the possibility of transmitting image data by the facsimile machine connected to the private branch network using the computer communication network when the gateway device includes the PBX function, has been found. Therefore, the gateway device with private branch exchanging function as to be described in the following has been invented based on this knowledge.

According to a first aspect of the present invention, there is provided a gateway device with private branch exchanging function which comprises means for connecting to each of a private branch network, a public switched telephone network, and a computer communication network, means for determining which network is to be used based on identifying information, in the case image data and the identifying information of the destination of the image data are received from the facsimile machine connected to the private branch network, and means for transmitting the image data to the determined network.

This gateway device includes means for connecting to each of the private branch network, the public switched telephone network, and the computer communication network is provided. Moreover, since the gateway device includes a private branch exchanging function and functions as a PBX, when the image data and the identifying information of the destination of the image data are input from the facsimile machine connected to the private branch network, the image data and the identifying information are transmitted to this gateway device from the facsimile machine. Then, when the image data and the identifying information are received, this gateway device determines whether or not to use the private branch network, to use only the public switched telephone network, or to use the computer communication network, by referring to the identifying information, and transmits the received image data to the determined network.

The identifying information includes such as a specific number or a mark (for example, “0”, “*”, “#”) attached to the front of the facsimile number, apart from the extension number or the facsimile number of the facsimile machine of the other end. By making the specific number or mark correspond to the public switched telephone network or the computer communication network, a transmission process of the image data is carried out by judging to which network of either the private branch network, the public switched telephone network or the computer communication network, the image data is to be transmitted.

Therefore, the user can transmit the image data through a desired network, just by inputting the image data and the identifying information of the destination from the facsimile machine connected to the private branch network.

According to a second aspect of the present invention, there is provide a gateway device with private branch exchanging function which further comprises judging means for judging whether or not the transmission of the image data to the computer communication network has been completed, and retransmitting means for transmitting the image data to the public switched telephone network in the case the judging means judges that the transmission has not been completed.

In this gateway device, when image data is transmitted to the computer communication network and the transmission fails, the retransmission process of the image data is carried out by using only the public switched telephone network. Accordingly, the image data can be reliably transmitted to the facsimile machine of the other end.

According to a third aspect of the present invention, there is provided a gateway device with private branch exchanging function which is characterized in that the retransmitting means makes confirmation of carrying out the retransmission of the image data to the public switched telephone network with the facsimile machine, and then transmits the image data to the public switched telephone network based on the result of the confirmation.

In this gateway device, the facsimile machine of the transmitting side is confirmed of carrying out the retransmission before carrying out the retransmission process of the image data. In the case an approval of the retransmission is earned from the confirmation, retransmission of the image data is carried out by utilizing only the public switched telephone network.

As in the manner stated above, when carrying out a retransmission process by using only the public switched telephone network, an approval of the user becomes necessary. Therefore, the user can deal with each circumstance such as instructing not to carry out retransmission when the transmission requires a considerable amount of communication expense, or instructing to carry out retransmission when there is a need to transmit the image data promptly.

According to a fourth aspect of the present invention, there is provide a gateway device with private branch exchanging function which further comprises means for carrying out the transmission of the image data to the computer communication network by T.38 protocol in real time communication.

In this gateway device, the transmission of the image data to the computer communication network is carried out by T.38 protocol in real time.

According to a fifth aspect of the present invention, there is provided a gateway device with private branch exchanging function which further comprises means for carrying out the transmission of the image data to the computer communication network in electronic mail format communication by SMTP (Simple Mail Transfer Protocol).

In this gateway device, the communication of the image data to the computer communication network is carried out in electronic mail format by SMTP.

Additional objects, aspects, benefits and advantages of the present invention will become apparent to those skilled in the art to which the present invention pertains from the subsequent detailed description and the appended claims, taken in conjunction with the accompanying drawings

### BREIF DESCRIPTION OF THE DRAWINGS

FIG. 1 is a block diagram showing one example of a formation of a gateway device according to the present invention and a private branch network, a public switched telephone network and a computer communication network which are connected to the gateway device;

FIG. 2 is a block diagram showing the formation of the gateway device of FIG. 1;

FIG. 3 is a view showing one example of a corresponding table;

FIG. 4 is a view showing one example of another corresponding table;

FIG. 5 is a flow chart showing a first embodiment of the flow of the operation performed by the gateway device of FIG. 1 when a facsimile machine carries out the transmission of the image data;

FIG. 6 is a flow chart showing a second embodiment of the flow of the operation performed by the gateway device of FIG. 1 when a facsimile machine carries out the transmission of the image data;

FIG. 7 is an illustration showing transmission and receiving process of the image data between the facsimile machines when carrying out the facsimile communication by utilizing the protocol of either T.38 or SMTP via the Internet as the computer communication network; and

FIG. 8 is a typical diagram showing an example of the content of the header of an electronic mail when carrying out facsimile communication by utilizing SMTP via the Internet as the computer communication network.

### DETAILED DESCRIPTION OF THE INVENTION

An embodiment of the present invention will be described in detail in reference to the accompanying drawings.

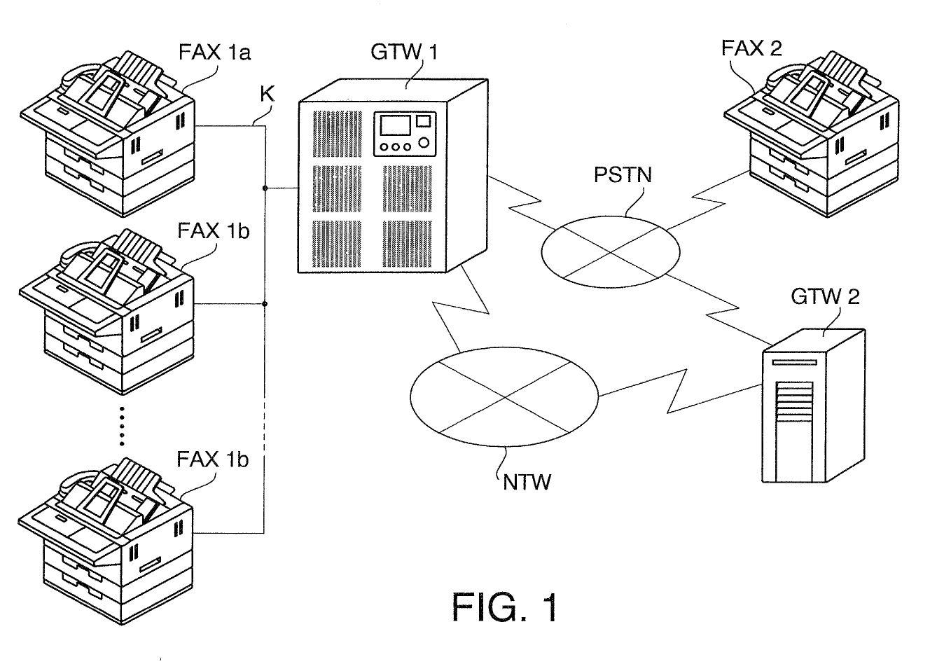

In FIG. 1, GTW1 designates an gateway device according to the present invention. The gateway device GTW1 is connected to each of a private branch network K, a public switched telephone network PSTN, and the Internet NTW which is the computer communication network. Moreover, the gateway device GTW1 according to the present invention includes a private branch exchanging function to be mentioned below, and functions as a PBX.

Moreover, FAX1a and FAX1b, FAX1b etc. shows facsimile machines connected to the private branch network K, and each of these facsimile machines FAX1a and FAX1b, FAX1b etc. can communicate with the gateway device GTW1 via the private branch network K. Furthermore, FAX2 designates a facsimile machine connected to the public switched telephone network PSTN, and the facsimile machine FAX2 can communicate with each of the gateway device GTW1 and the gateway device GTW2 via the public switched telephone network PSTN.

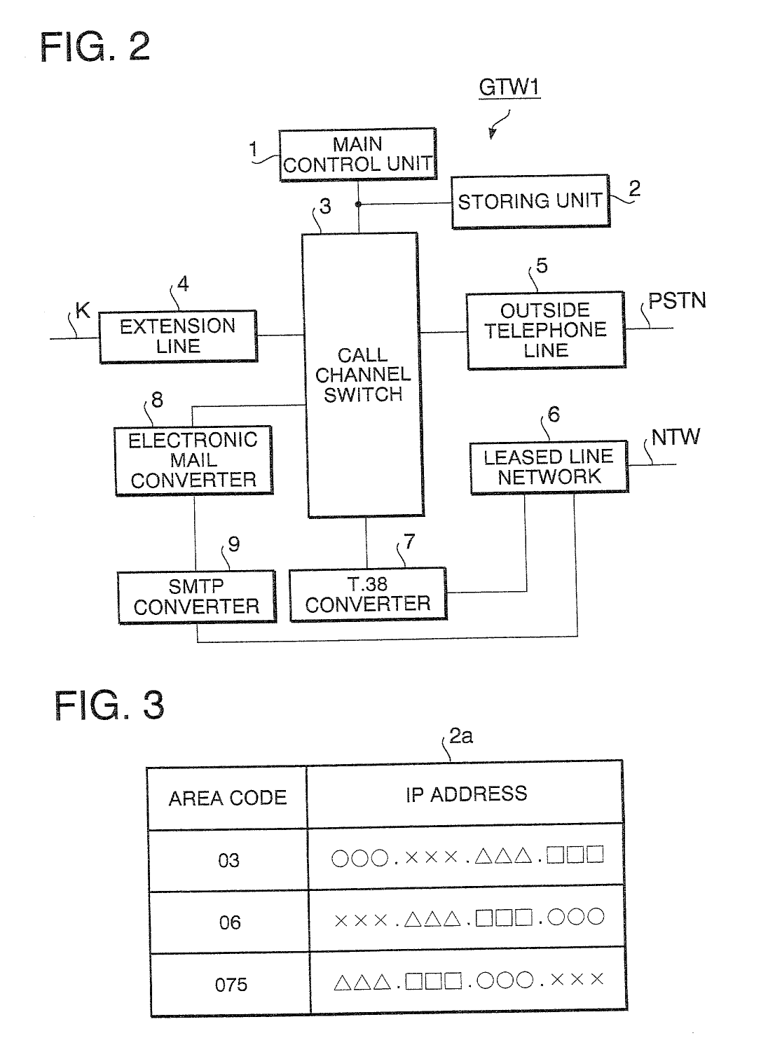

In FIG. 2, the reference number 1 designates a main control unit including CPU, and the main control unit 1 executes various programs stored in a storing unit 2 while controlling each part of the hard wear to be mentioned below.

The storing unit 2 comprises such as SRAM or DRAM, and stores programs of various software necessary for the operation of the gateway device GTW1.

Moreover, in an appropriate area of the storing unit 2, a corresponding table 2a as shown in FIG. 3, which shows the correspondence between the area code and the IP address of the gateway device GTW2 located in the area related to the area code, is stored. Further, the corresponding table 2a can be deleted, updated or added by the operation of a user.

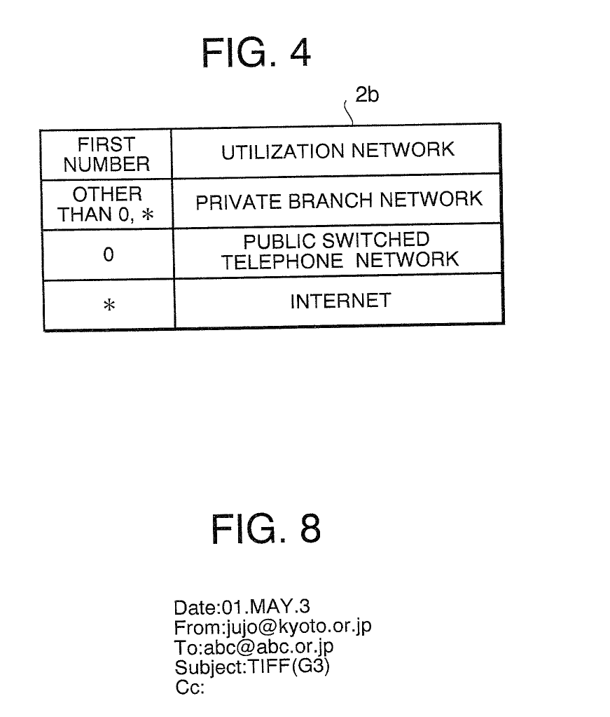

Stored in the appropriate area of the storing unit 2 is a corresponding table 2b as shown in FIG. 4 which illustrates the relationship between the number to be attached to the front of the facsimile number of the other end (hereafter referred to as the first number) and the communication network to be used. As shown in FIG. 4, in the corresponding table 2b, when the first number is a number other than “0” and “*”, it corresponds to the private branch network K, when first number is “0”, it corresponds to the public switched telephone network PSTN, and when the first number is “*”, it corresponds to the Internet NTW. Further, this corresponding table 2a can also be deleted, updated or added by the operation of a user.

A call channel switch 3 is a device for making a setting of the call channel between respective communication devices to carry out transmission and receiving of the communication data between a plurality of communication devices which are connected to the networks of the private branch network K, the public switched telephone network PSTN and the Internet NTW, respectively.

An extension line 4 is a line for connecting the private branch network K. The gateway device GTW1 is capable of communicating, via the extension line 4, with the communication devices such as the facsimile machines FAX1a and FAX1b, FAX1b etc. which are connected to the private branch network K.

An outside telephone line 5 is a line for connecting the public switched telephone network PSTN. The gateway device GTW1 is capable of communicating, via the outside telephone line 5, with the communication devices such as the facsimile machine FAX2 which is connected to the public switched telephone network PSTN.

A leased line network 6 is a network for including a leased line used for connecting to the Internet NTW, and transmits and receives the data converted by the protocol via T.38 converter and SMTP converter 9. Via the leased line circuit 6, the gateway device GTW1 is capable of communicating, by T.38, SMTP or the like, with the communication machines such as the gateway device GTW2 connected to the Internet NTW.

Since the protocol conversion by T.38 converter 7 and SMTP converter 9 are publicly known, its explanation will be omitted. However, when carrying out the communication by SMTP converter 9 via the Internet NTW, an electronic mail converter 8 is required to convert facsimile image data into an electronic mail format or to reversibly convert an electronic mail format into facsimile image data. This process is also well known by the public, and thus the explanation will be omitted.

Further, the transmission and receiving of the image data by the facsimile communication, via the Internet NTW, between both gateway devices GTW1, GTW2 is capable of selectively using either or both of the real time Internet by T.38 protocol and an electronic mail utilizing SMTP. Therefore, T.38 converter 7, the electronic mail converter 8 and SMTP converter 9 are also provided in the gateway device GTW2 in the same manner as the gateway device GTW1.

Next, a first embodiment of the operation of the gateway device GTW1 according to the present invention will be described.

A user inputs, from the facsimile machine FAX1a, the extension number of the facsimile machine FAX1b of the other end or the number of the destination which is the facsimile number of the facsimile machine FAX2. When carrying out facsimile communication by using only the public switched telephone network PSTN, the number of the other end with “0” attached as the first number is input. When carrying out facsimile communication by using the Internet NTW, the number of the destination with “*” attached as the first number is input. Moreover, when carrying out facsimile communication by using the private branch network K, the extension number is to be the number of the destination. However, in this case, the user inputs the extension number without attaching a first number such as “0” or “*”.

Moreover, the user inputs the image data by making the facsimile machine FAX1a read the image data which is to be transmitted, along with inputting the number of the destination as in the manner stated above. These numbers of the destination and the image data are transmitted automatically to the gateway device GTW1 with PBX function from the facsimile machine FAX1a via the private branch network K.

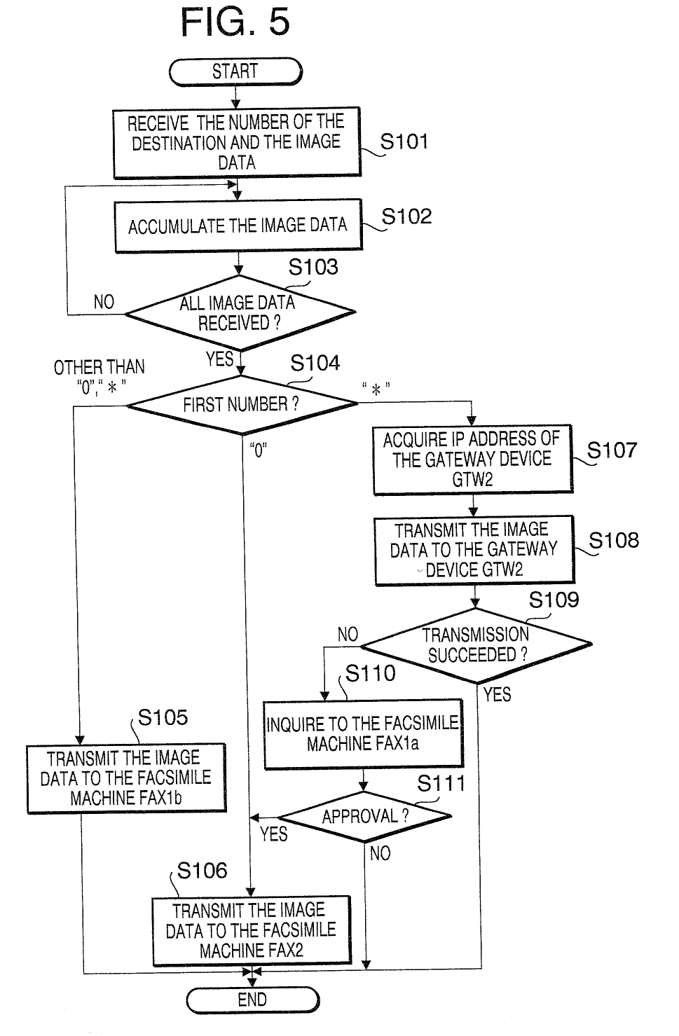

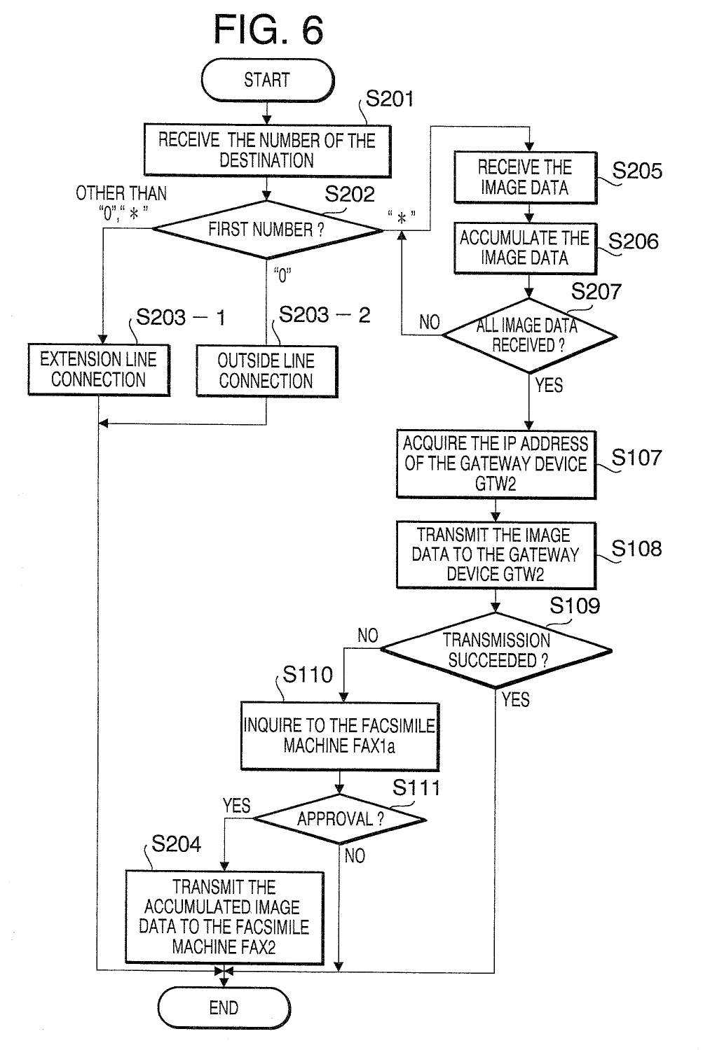

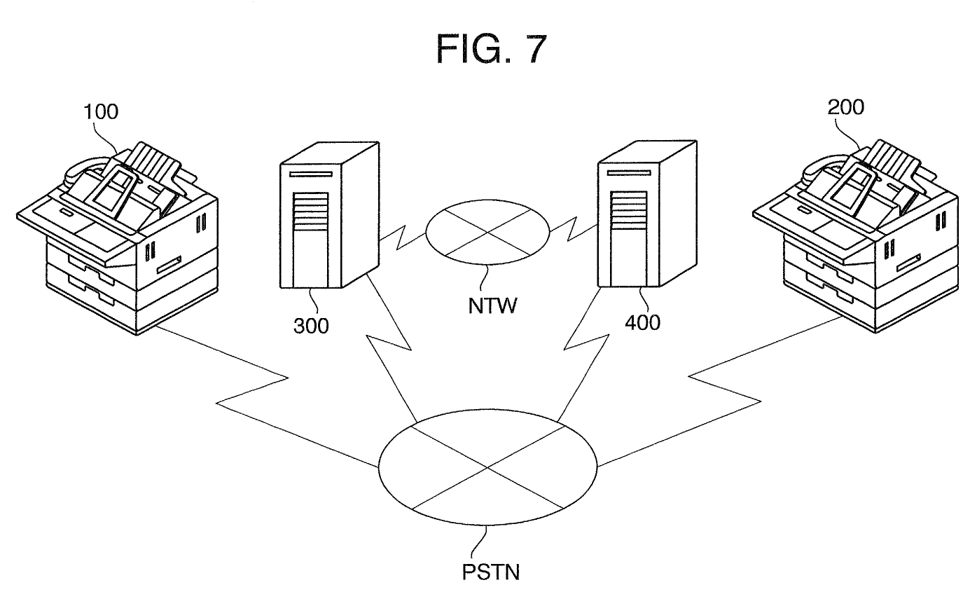

Referring to FIG. 5, when receiving the number of the destination and the image data from the facsimile machine FAX1a (S101), the gateway device GTW1 stores the number of the destination temporarily in the storing unit 2, and accumulates and stores the received image data in the storing unit 2 one after another (S102). When receiving all image data (S103:YES), in other words, when all image data are accumulated in the storing unit 2, the first numbers are distinguished referring to the number of the destination received beforehand and stored temporarily in the storing unit 2 (S104). When it is determined that the first number is a number other than “0”, and “*” (S104: other than “0”, “*”), it is confirmed to carry out the transmission process using the private branch network K in reference to the corresponding table 2b mentioned above. Then, the facsimile machine FAX1b related to the number of the destination (extension number) received in step S101 is called, and when there is a response from the facsimile machine FAX1b, the image data accumulated also in step S102 is transmitted to the facsimile machine FAX1b via the private branch network K (step S105), and the process is completed.

Moreover, when the first number is distinguished to be “0” in step S104 (S104:“0”), by referring to the corresponding table 2b, it is confirmed to carry out the transmission process using only the public switched telephone network PSTN. Then, the facsimile machine FAX2 related to the number of the destination (facsimile number) received and temporarily stored in the storing unit 2 in step S101 is called, and when there is a response from the facsimile machine FAX2, the image data accumulated in step S102 is transmitted under regular facsimile communication following the ITU recommendation T.30 to the facsimile machine FAX2 via only the public switched telephone network PSTN (S106), and the process is completed.

Furthermore, when the first number is distinguished to be “*” n step S104 (S104:“*”), by referring to the corresponding table 2b, it is confirmed to carry out the transmission process using the Internet NTW. Next, the IP address of the gateway device GTW2 located in the area of the area code is acquired by referring to the area code of the destination number (facsimile number) received and temporarily stored in the storing unit 2 in step S101, and referring to the corresponding table 2a (S107). By specifying the acquired IP address as the destination, the accumulated image data in step S102, and the destination number for the facsimile machine FAX2 with the first number eliminated are transmitted to the gateway device GTW2 via the Internet NTW under the ITU recommendation T.38 (S108).

In such case, when communication by T.38 protocol is carried out between the gateway device GTW1 and the gateway device GTW2, the gateway device GTW1 transmits the image data by converting the image data into a digital signal following the standard of T.38 protocol. Moreover, when the communication by SMTP is carried out, the gateway device GTW1 transmits the image data by converting the image data into an electronic mail format as mentioned above. In this manner, the image data is transmitted to the gateway device GTW2 via the Internet NTW from the gateway device GTW1, when the communication is carried out by either protocol of T.38 or SMTP.

When the gateway device GTW2 receives the image data transmitted in the manner stated above and the communication by T.38 protocol is carried out, the gateway device GTW2 modulates the received digital signal into an analog voice signal, and transmits the signal via the public switched telephone network PSTN following T.30 mentioned above to the facsimile machine FAX2 based on the received destination number. When the communication by SMTP is carried out, the gateway device GTW2 converts the text data of the received electronic mail into binary data, converts further into facsimile image data to modulate into an analog voice signal, and transmits the signal to the facsimile machine FAX2 based on the received destination number via the public switched telephone network PSTN following aforementioned T.30. As a result, the facsimile machine FAX2 which is the final destination can receive the image data.

After step S108 is carried out, the gateway device GTW1 judges whether or not the transmission of the image data has succeeded (S109). This judgment is carried out, by receiving from the gateway device GTW2 of the other end, the information indicating that the receiving of the image data has been competed normally (or the information indicating that the receiving of the image data has not been completed normally), for example. Then, when it is judged that the transmission has succeeded (S109:YES), the process is terminated.

On the other hand, when it is judged that the transmission has failed in step S109 (S109:NO), it is inquired of the facsimile machine FAX1a whether or not to approve transmitting the image data directly to the facsimile machine FAX2 via the public switched telephone PSTN (S110). This transmitting will be referred to as retransmission.

When receiving the inquiry from the gateway device GTW1, the facsimile machine FAX1a displays, on the displaying screen, the input screen for accepting the input of the instructing information indicating whether or not to approve the retransmission. Then, when receiving an input of the instructing information from the user, the instructing information is transmitted to the gateway device GTW1.

When receiving the instructing information from the facsimile machine FAX1a, the gateway device GTW1 judges whether or not an approval of the retransmission has been acquired by referring to the instructing information (S111). When it is judged that the approval has not been acquired (S111:NO), the process ends here. On the other hand, when it is judged that the approval has been acquired (S111:YES), by carrying out the process in step S106 mentioned above, the image data accumulated in step S102 is transmitted directly to the facsimile machine FAX2 via only the public switched telephone network PSTN. As a result, the image data can be reliably transmitted to the facsimile machine FAX2.

Next, a second embodiment of the operation of the gateway device GTW1 according to the present invention will be described.

A user inputs, from the facsimile machine FAX1a, the extension number of the facsimile machine FAX1b of the other end or the destination number which is the facsimile number of the facsimile machine FAX2. When carrying out facsimile communication by using only the public switched telephone network PSTN, the destination number with “0” attached as the first number is input, and when carrying out facsimile communication by using the Internet NTW, the destination number with “*” attached in the same manner is input. Furthermore, when carrying out facsimile communication by using the private branch network K, the extension number is to be the destination number. However, in such case, the user inputs the extension number without attaching any first number such as “0” or “*”.

Moreover, the user inputs the destination number as in the manner stated above, and also inputs the image data by making the facsimile machine FAX1a read the image data which is to be transmitted. The destination number and the image data are transmitted automatically to the gateway device GTW1 with PBX function from the facsimile machine FAX1a via the private branch network K.

When receiving the destination number from the facsimile machine FAX1a (S201), the gateway device GTW1 stores the destination number temporarily in the storing unit 2, and judges the first number in reference to the received destination number (S202). When it is judged that the first number is a number other than “0” and “*” (S202:other than “0”, “*”), it is confirmed to carry out the transmission process using the private branch network K in reference to the corresponding table 2b mentioned above. Then, the facsimile machine FAX1b related to the destination number (extension number) received in step S201 is called by connecting the line (S203-1), and the image data is transmitted from the facsimile machine FAX1a to the facsimile machine FAX1b via the private branch network K, and the process is completed.

Moreover, when it is judged that the first number is “0” in step S202 (S202:“0”), it is confirmed to carry out the transmission process using only the public switched telephone network PSTN by referring to the corresponding table 2b. Then, the facsimile machine FAX2 related to the destination number (facsimile number) received in step S201 is called by connecting the line (S203-2), and the image data is transmitted by the facsimile communication under the ITU recommendation T.30 to the facsimile machine FAX2 from the facsimile machine FAX1a via only the public switched telephone network PSTN, and the process is completed.

Furthermore, when it is judged that the first number is “*” in step S202 (S202:“*”), it is confirmed to carry out the transmission process using the Internet NTW in reference to the corresponding table 2b. In this case, the gateway device GTW1 receives the image data from the facsimile machine FAX1a (S205), and the received data is accumulated and stored in the storing unit 2 one after another (S206). When all image data is received (S207:YES), in other words, when all image data is accumulated in the storing unit 2, the IP address of the gateway device GTW2 located in the area related to the area code is acquired (S107) by referring to the area code of the destination number (facsimile number) received and stored temporarily in the storing unit 2 in step S201 and to the corresponding table 2a. By appointing the acquired IP address for the destination, the image data accumulated in step S206 and the destination number of the facsimile machine FAX2 with the first number excluded are transmitted to the gateway device GTW2 via the Internet NTW following SMTP or the ITU recommendation T.38 (S108).

The operation following step S108 is the same as step S109 through S111 of the first embodiment shown in the flow chart of FIG. 5. Therefore, the explanation will be omitted. Further, in the same manner as the first embodiment, also in the second embodiment, when the gateway device GTW1 can obtain the approval of the retransmission in the case of failure in the transmission of the image data (S111:YES), the image data accumulated in step S206 can be retransmitted directly to the facsimile machine FAX2 via only the public switched telephone network PSTN (S204). As a result, the image data can reliably be transmitted to the facsimile machine FAX2.

Further, according to the second embodiment, when carrying out facsimile transmission via the Internet NTW, the image data is temporarily accumulated in step S206. However, when carrying out a real time Internet facsimile communication, there is no need to accumulate the image data in step S206. When the image data is not to be accumulated in step S206, the retransmission of the image data in step S204 cannot be carried out.

Further, according to both embodiments described above, the communication carried out in the computer communication network (Internet) between the gateway device GTW1 and the gateway device GTW2 followed a protocol of either T.38 or SMTP. However, it is not to be limited to such manner, and other protocol can be used if it is able to transmit and receive the facsimile image data.

As in the manner stated above in a detail, according to the gateway device of the present invention, when the image data and the identifying information of the facsimile number of the other end are received from the facsimile machine connected to the private branch network, based on such identifying information, it is judged whether or not to use the private branch network, to use only the public switched telephone network, or to use the computer communication network. By carrying out transmission of the image data to the determined network, the transmission of the image data using the desired network can be carried out without any complicated operation by the user from the facsimile machine of the transmitting side.

Moreover, according to the gateway device of the present invention, when the transmission of the image data to the computer communication network fails, by retransmitting the same image data by utilizing only the public switched telephone network, the transmission of the image data can be reliably completed.

Furthermore, according to the gateway device of the present invention, the retransmission process of the image data using only the public switched telephone network is carried out only after achieving an approval from the user. Therefore, when a considerable communication expense is required for the retransmission process, the user can make an order not to carry out the retransmission process, and when there is a need to transmit the image data promptly, the user can make an order to carry out the retransmission process. Likewise, the present invention benefits in that the user can deal according to each circumstance.

In addition, according to the gateway device of the present invention, since the communication of the image data to the computer communication network is carried out by T.38 protocol in real time, it benefits in a superior effect that the facsimile communication can be carried out at a low expense and in real time by utilizing the computer communication network.

Furthermore, according to the gateway device of the present invention, since the communication of the image data to the computer communication network is carried out in an electronic mail format by SMTP, it benefits in a superior effect that the facsimile communication can be carried out at a low expense by utilizing the computer communication network.

What is claimed is:

1. A gateway device with private branch exchanging function comprising:
means for connecting with each of a private exchanging network, a public switched telephone network, and a computer communication network;
means for determining which network is to be used based on identifying information, when receiving image data and the identifying information of a destination of the image data from a facsimile machine connected to the private exchanging network; and
means for transmitting the image data to the determined network.

2. The gateway device with private branch exchanging function according to claim 1 further comprising:
means for judging whether or not the transmission of the image data to the computer communication network has been completed; and
retransmitting means for retransmitting the image data to the public switched telephone network when the means for judging judges that the transmission has not been completed.

3. The gateway device with private branch exchanging function according to claim 2 wherein the retransmitting means makes confirmation of carrying out the transmission of the image data to the public switched telephone network with the facsimile machine, and transmits or does not transmit the image data to the public switched telephone network based on a result of the confirmation.

4. The gateway device with private branch exchanging function according to claim 1 further comprising:
means for carrying out the transmission of the image data to the computer communication network in real time communication by T.38 protocol.

5. The gateway device with private branch exchanging function according to claim 2 further comprising:
means for carrying out the transmission of the image data to the computer communication network in real time communication by T.38 protocol.

6. The gateway device with private branch exchanging function according to claim 3 further comprising:
means for carrying out the transmission of the image data to the computer communication network in real time communication by T.38 protocol.

7. The gateway device with private branch exchanging function according to claim 1 further comprising:
means for carrying out the transmission of the image data to the computer communication network in electronic mail format communication by SMTP (Simple Mail Transfer Protocol).

8. The gateway device with private branch exchanging function according to claim 2 further comprising:
means for carrying out the transmission of the image data to the computer communication network in electronic mail format communication by SMTP (Simple Mail Transfer Protocol).

9. The gateway device with private branch exchanging function according to claim 3 further comprising:
means for carrying out the transmission of the image data to the computer communication network in electronic mail format communication by SMTP (Simple Mail Transfer Protocol).

10. A gateway device with private branch exchanging function comprising:
means for connecting with each of a private branch network, a public switched telephone network and a computer communication network; and
means for determining which network is to be used based on identifying information when receiving the identifying information of a destination from a facsimile machine connected to the private branch network.

11. The gateway device with private branch exchanging function according to claim 10 further comprising:
means for receiving image data from the facsimile machine, accumulating the received image data when the means for determining determines that the computer communication network is to be used, and then transmitting the image data to the computer communication network.

12. The gateway device with private branch exchanging function according to claim 10, wherein the means for connecting connects the facsimile machine to the private branch network when the means for determining determines that the private branch network is to be used, and connects the facsimile machine to the public switched telephone network when the means for determining determines that the public switched telephone network is to be used.

13. The gateway device with private branch exchanging function according to claim 11 further including:
means for acquiring an IP address of another gateway device located in an area related to the destination, based on the identifying information when the computer communication network is to be used, wherein the image data is transmitted to the another gateway device.

14. The gateway device with private branch exchanging function according to claim 11 further including:
means for judging whether or not the transmission of the image data to the computer communication network has been completed.

15. The gateway device with private branch exchanging function according to claim 14 further including:
means for making confirmation of carrying out retransmission of the image data with the facsimile machine when the means for judging judges that the transmission of the image data to the computer communication network has not been completed; and
retransmitting means for retransmitting the image data to the public switched telephone network when a result of the confirmation is approval of the retransmission.

16. A method of transmitting image data comprising the steps of:
(A) receiving image data and information of a destination of the image data from a facsimile machine connected to a private exchanging network;
(B) determining which network of the private exchanging network, a public switched telephone network, and a computer communication network is to be used; and
(C) transmitting the image data to the network determined in step (B).

17. The method according to claim 16 further including the step of (D) judging whether or not transmission of the image dada has been completed when the image data is transmitted to the computer network in step (C).

18. The method according to claim 17 further including the steps of:
(E) asking the facsimile machine whether or not retransmission of the image data to the public switched telephone network is to be carried out when in step (D), it is judged that the transmission of the image data has not been completed; and
retransmitting the image data to the public switched telephone network when a result of asking in step (E) is approval of retransmition.

19. The method according to claim 16, wherein when the network determined in step (B) is the computer network, the transmission of the image data is carried out in real time communication by T.38 protocol in step (C).

20. The method according to claim 16 wherein when the network determined in step (B) is the computer network, the transmission of the image data is carried out in electronic mail format communication by SMTP (Simple Mail Transfer Protocol) in step (C).
